(19) United States
(12) Patent Application Publication
(10) Pub. No.: US 2015/0302824 A1
(43) Pub. Date: Oct. 22, 2015

(54) DISPLAY DEVICE AND COLOR CALIBRATION METHOD

(71) Applicant: NEC Display Solutions ,Ltd., Tokyo (JP)

(72) Inventor: Hiroaki MATSUSHITA, Tokyo (JP)

(21) Appl. No.: 14/435,419

(22) PCT Filed: Oct. 22, 2012
(86) PCT No.: PCT/JP2012/077235

§ 371 Date: Apr. 13, 2015

(51) Int. Cl. G09G 5/02

(52) U.S. Cl. CPC G09G 5/02; G09G 2320/0693; G09G 2320/0242

(57) ABSTRACT

A display device has a color sensor position detecting unit that detects a contact position between a color sensor and the display device; and a control operation unit that determines whether or not positional misalignment of the color sensor has occurred, based on the contact position detected by the color sensor position detecting unit.

### TECHNICAL FIELD

The present invention relates to a technology for detecting positional misalignment of an external color sensor in color calibration for colors displayed by a display device.

### BACKGROUND ART

Recently, color management to match the color of different devices such as a digital camera, a scanner, a printer, a display, and the like is becoming more common. For example, regarding a display used in photo or video production in a professional field, a method of performing color calibration utilizing an external color sensor (employed for the color calibration of displayed colors) is known (see, for example, Patent Document 1).

### PRIOR ART DOCUMENT

### Patent Document

Patent Document 1: Japanese Unexamined Patent Application, First Publication No. 2010-169922.

### DISCLOSURE OF INVENTION

### Problem to be Solved by the Invention

However, when performing the color calibration by attaching a color sensor to the outside of the display device, the contact point between the display device and the color sensor may deviate from a correct point due to an external cause such as unexpected impact, vibration, or the like, which degrades the accuracy of results of the calibration.

In addition, since the color calibration requires a certain time, the user may leave the relevant place while the color calibration is executed. If the contact point between the display device and the color sensor deviate from a correct point while the user is absent, the user cannot detect the deviation. As a result, the color calibration must be executed again from the beginning.

In order to solve the above problem, an object of the present invention is to provide a technique for detecting positional misalignment of a color sensor externally attached to a display device.

### Means for Solving the Problem

In order to solve the above problem, the present invention provides a display device comprising:

a color sensor position detecting unit that detects a contact position between a color sensor and the display device; and

a control operation unit that determines whether or not positional misalignment of the color sensor has occurred, based on the contact position detected by the color sensor position detecting unit.

The present invention also provides a color calibration method comprising:

a color sensor position detecting step that detects a contact position between a color sensor and the display device; and

a control operation step that determines whether or not positional misalignment of the color sensor has occurred, based on the contact position detected in the color sensor position detecting step.

### Effect of the Invention

According to the present invention, in the color calibration for the display device, the contact position between the color sensor and the display device is detected so that it is possible to prevent the color calibration accuracy from being degraded.

### BRIEF DESCRIPTION OF THE DRAWINGS

FIG. 1 is a block diagram that indicates an embodiment of the display device of the present invention.

FIG. 2 is a diagram showing the general structure of a display device according to an embodiment of the present invention.

FIG. 3 is a block diagram showing electrical connection of the display device according to the embodiment of FIG. 2.

FIG. 4A is a diagram utilized to explain how the color calibration of the display device in the embodiment of FIG. 2 is performed.

FIG. 4B is a diagram utilized to explain a state in which the positional misalignment of a color sensor has occurred during the color calibration of the display device in the embodiment of FIG. 2.

FIG. 5 is a flowchart showing a color sensor positional misalignment detecting process of the display device in the embodiment of FIG. 2.

### MODE FOR CARRYING OUT THE INVENTION

Below, embodiments to implement the present invention will be explained with reference to the drawings.

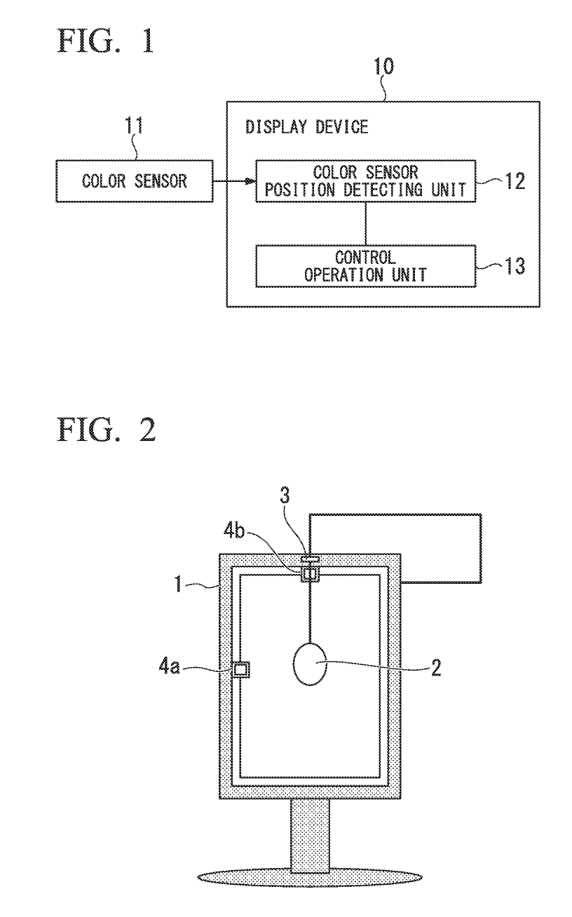

FIG. 1 is a block diagram that indicates an embodiment of the display device of the present invention.

A color sensor position detecting unit 12 detects a contact point between a color sensor 11 and a display device 10. A control computation unit 13 determines whether or not positional misalignment of the color sensor 11 has occurred, based on the contact position detected by the color sensor position detecting unit 12. The display device 10 performs color calibration using a result of the determination.

FIG. 2 is a diagram showing the general structure of a display device 1 according to an embodiment of the present invention.

As shown in FIG. 2, the display device 1 has an external color sensor 2, a sensor fixing part 3, a position detection sensor 4a for a position in the vertical direction, and a position detecting sensor 4b for a position in the horizontal direction.

The display device 1 may be a liquid crystal display. The color sensor 2 may be an external color sensor utilizing USB connection and detects information about colors displayed by the display device 1 (called “color information” below). The sensor fixing part 3 may be an adhesive component, such as a tape, utilized to fasten the color sensor 2 to the display device 1. The position detection sensors 4 may be Hall sensors and detects the contact position between the color sensor 2 and the display device 1.

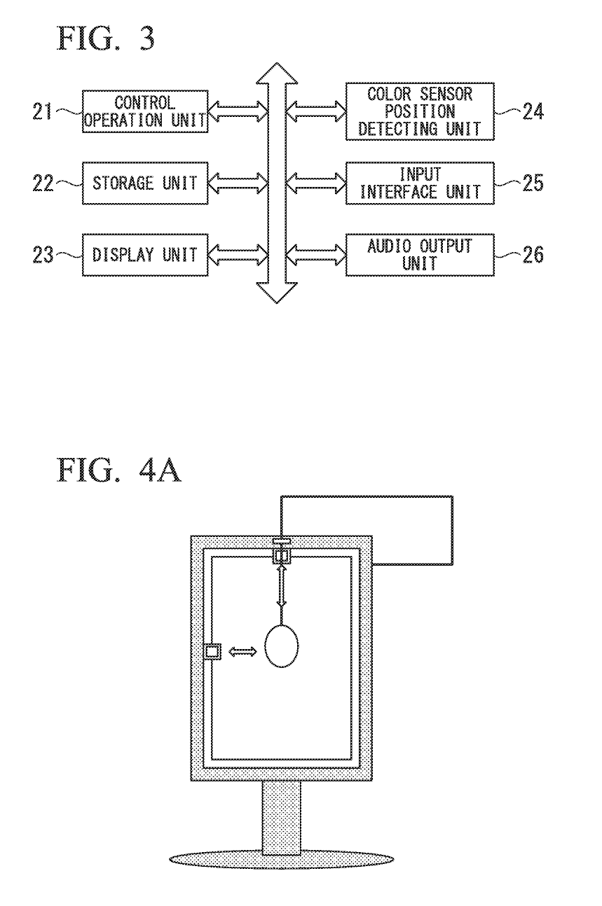

FIG. 3 is a block diagram showing electrical connection of the display device 1 according to the present embodiment.

The display device 1 includes a control operation unit 21, a storage unit 22, a display unit 23, a color sensor position detecting unit 24, an input interface unit 25, and an audio output unit 26.

The control operation unit 21 performs operations required to necessary control so as to control the units (except for the control operation unit 21) in FIG. 3. For example, the control operation unit 21 determines whether or not positional misalignment of the color sensor 2 has occurred, based on position data output from the color sensor position detecting unit 24.

The storage unit 22 stores data utilized in various programs, control, and operations, which are executed by the control operation unit 21. The programs include a setting program utilizing an OSD (On Screen Display), a color calibration program, a color sensor positional misalignment detection program, and the like.

The display unit 23 displays images, characters, a screen for application software operation, or the like. The display unit 23 also functions as a notification unit. For example, the display unit 23 displays a warning message on an OSD (On Screen Display) to communicate that positional misalignment of the color sensor 2 has occurred, so as to inform the user of the occurrence.

The color sensor position detecting unit 24 outputs position data, which is detected by the position detection sensors 4, to the control operation unit 21.

An input device such as a keyboard, a mouse, the color sensor, and the like are connected to the input interface unit 25 so as to input various information items required for the relevant control and operation. In the present embodiment explained below, a keyboard and the color sensor 2 are connected to the input interface unit 25.

The audio output unit 26 outputs an alarm sound when the control operation unit 21 has determined, based on the position data output from the color sensor position detecting unit 24, that the positional misalignment has occurred. That is, the audio output unit 26 functions as a notification unit.

In the above-explained embodiment, the display unit 23 and the audio output unit 26 inform the user of the occurrence of the positional misalignment of the color sensor 2. However, the present invention is not limited to such a process, and any one of the above units may inform the user of the occurrence of the positional misalignment of the color sensor 2. Additionally, the notification method needs not to be limited by the structure of the display device 1. For example, if the display device 1 is connected to a network, an email message to communicate the occurrence of the positional misalignment of the color sensor 2 may be sent to a portable terminal or the like of the user.

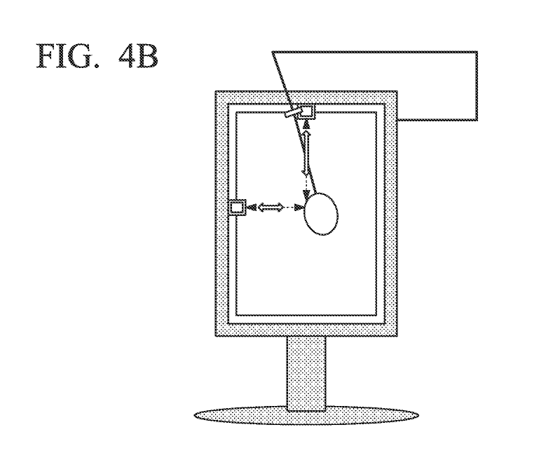

FIG. 4A is a diagram utilized to explain how the color calibration of the display device 1 is performed.

FIG. 4B is a diagram utilized to explain a state in which the positional misalignment of the color sensor 2 has occurred during the color calibration of the display device 1.

In the display device 1 having an external color sensor shown in FIG. 4A, the position of the color sensor 2 is fixed to a predetermined position and the color calibration is successful.

In contrast, in the display device 1 having an external color sensor shown in FIG. 4B, the positional misalignment of the color sensor 2 has occurred during the color calibration. More specifically, the fixed position of the sensor fixing part 3 is displaced due to vibration or impact from the external environment, so that the contact position between the color sensor 2 and the display device 1 deviate from the correct point. If the color calibration is continued in this state, the accuracy of the color calibration may be degraded or a failure in the calibration may occur.

Since the display device 1 of the present embodiment has the position detection sensor 4a for a position in the vertical direction and the position detecting sensor 4b for a position in the horizontal direction, it is possible to detects the contact position between the color sensor 2 and the display device 1.

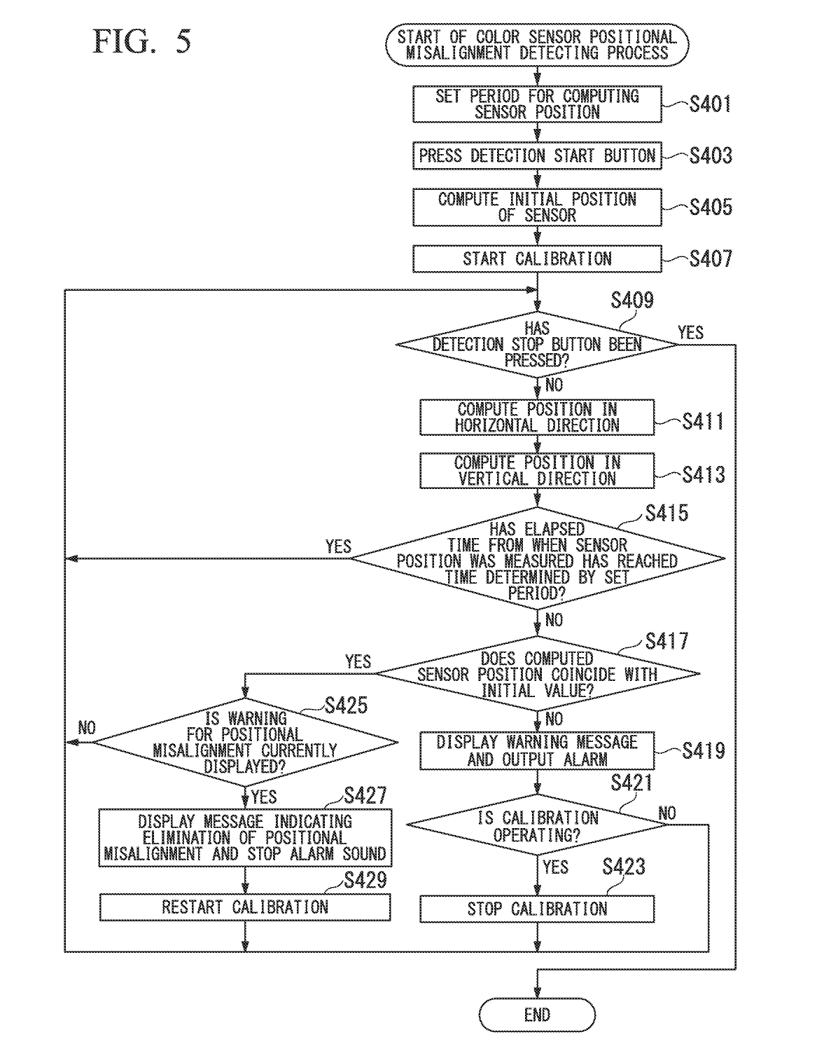

FIG. 5 is a flowchart showing a color sensor positional misalignment detecting process of the display device 1 in the present embodiment.

The color sensor positional misalignment detecting process of the display device 1 will be explained with reference to the flowchart of FIG. 5.

In order to start the color sensor positional misalignment detecting process, the control operation unit 21 executes a color sensor positional misalignment detection program stored in the storage unit 22.

The period for computation of the sensor position is set by means of the input device such as a keyboard connected to the input interface unit 25, and the storage unit 22 stores the set value (see step S401).

The control operation unit 21 starts the color sensor positional misalignment detecting process when a detection start button, which is displayed as an operation button in the color sensor positional misalignment detection program, is pressed (see step S403).

Based on the position data obtained by the color sensor position detecting unit 24 from the position detection sensors 4, the control operation unit 21 computes initial position data of the color sensor 2 (see step S405). The storage unit 22 stores the computed initial position data.

The control operation unit 21 executes a color calibration program storage stored in the storage unit 22 (see step S407).

The control operation unit 21 determines whether or not a detection stop button utilized in the color sensor positional misalignment detection program has been pressed (see step S409).

If the detection stop button has been pressed (i.e., “YES” in step S409), the control operation unit 21 terminates the process.

In contrast, if the detection stop button has not yet been pressed (i.e., “NO” in step S409), the control operation unit 21 computes the position of the color sensor 2 in the horizontal direction based on the data which the color sensor position detecting section 24 obtains from the position detecting sensor 4b (see step S411).

The control operation unit 21 computes the position of the color sensor 2 in the vertical direction based on the data which the color sensor position detecting section 24 obtains from the position detecting sensor 4a (see step S413). The control operation unit 21 then computes the position data of the color sensor 2 based on the vertical position data and the horizontal position data of the color sensor 2.

The control operation unit 21 determines whether or not the elapsed time from when the sensor position was measured has reached a time determined by the set period (see step S415).

If the elapsed time has reached the time determined by the set period (i.e., “YES” in step S415), the operation returns to step S409.

In contrast, if the elapsed time has not yet reached the time determined by the set period (i.e., “NO” in step S415), the control operation unit 21 refers to the initial position data (stored in the storage unit 22) of the color sensor 2 and determines whether or not the initial position data coincides with the computed position data (see step S417). Here, the criteria for the above determination does not always require that the compared positions are completely the same. For example, the determination may be performed based on a predetermined threshold for the allowable error.

In the process of step S417, if the initial position data and the computed position data of the color sensor 2 do not coincide with each other (i.e., “NO” in step S417), the control operation unit 21 displays a warning message indicating the positional misalignment of the sensor by means of the OSD on the display unit 23. Simultaneously, the control operation unit 21 makes the audio output unit 26 output an alarm sound (see step S419).

The control operation unit 21 then determines whether or not the color calibration program is operating (see step S421).

If the color calibration program is operating (i.e., “YES” in step S421), the control operation unit 21 stop the color calibration program (step S423) and the operation returns to step S409.

In contrast, if the color calibration program is not operating (i.e., “NO” in step S421), the operation returns to step S409.

In the process of step S417, if the initial position data and the computed position data of the color sensor 2 coincide with each other (i.e., “YES” in step S417), the control operation unit 21 determines whether or not the display unit 23 is displaying the warning for the positional misalignment (see step S425).

If the warning for the positional misalignment is currently displayed (i.e., “YES” in step S425), the control operation unit 21 displays a message indicating that the positional misalignment has been eliminated, by means of the OSD on the display unit 23. Simultaneously, the control operation unit 21 stops the alarm sound output from the audio output unit 26 (see step S427).

The control operation unit 21 then restarts the color calibration program (see step S429) and the operation returns to step S409.

In contrast, if the warning for the positional misalignment is not currently displayed (i.e., “NO” in step S425), the operation returns to step S409.

Therefore, according to the display device 1 of the present embodiment, when the color calibration is executed, it is possible to detect the contact position between the color sensor 2 and the display device 1. Additionally, if the positional misalignment has been detected, it is possible to inform the user of such an abnormal condition.

Accordingly, in the color calibration of the display device 1 in which the contact position between the color sensor 2 and the display device 1 is detected, it is possible to prevent the color calibration accuracy from being degraded.

A program for executing the functions of the display device having an external color sensor in FIG. 1 may be stored in a computer readable storage medium, and the program stored in the storage medium may be loaded and executed on a computer system, so as to perform the relevant operation and management. Here, the computer system has hardware resources which include an OS and peripheral devices.

If the computer system employs a WWW system, the computer system can provide a homepage service (or viewable) environment.

The above computer readable storage medium is a storage device, for example, a portable medium such as a flexible disk, a magneto optical disk, a ROM, or a CD-ROM, or a memory device such as a hard disk built in a computer system. The computer readable storage medium also covers a device for temporarily storing the program, such as a volatile storage medium in a computer system which functions as a server or client. In addition, the program may execute part of the above-explained functions, or may be a program by which the above-described functions can be executed by a combination of this program and an existing program which has already been stored in the relevant computer system. In addition, the above-described program may be stored in a specific server and distributed via a communication line (due to downloading or the like) in response to a request from other devices.

The embodiments of the present invention have been explained in detail with reference to the drawings. However, concrete structures are not limited to the embodiments and also include design modifications or the like, within the scope of the present invention.

### REFERENCE SYMBOLS

1, 10 display device

2, 11 color sensor

3 sensor fixing part

4 position detecting sensor

4a (vertical) position detecting sensor

4b (horizontal) position detecting sensor

12, 24 color sensor position detecting unit

13, 21 control computation unit

22 storage unit

23 display unit

25 input interface unit

26 audio output unit

1. A display device comprising:
a color sensor position detecting unit that detects a contact position between a color sensor and the display device; and
a control operation unit that determines whether or not positional misalignment of the color sensor has occurred, based on the contact position detected by the color sensor position detecting unit.

2. The display device in accordance with claim 1, further comprising:
a notification unit that informs a user of the occurrence of the positional misalignment if the control operation unit determines that the positional misalignment of the color sensor has occurred.

3. The display device in accordance with claim 1, wherein:
the control operation unit stops a color calibration operation when the positional misalignment of the color sensor has occurred.

4. A color calibration method comprising:
detecting a contact position between a color sensor and the display device; and
detecting whether or not positional misalignment of the color sensor has occurred, based on the contact position detected in the detecting.

5. The display device in accordance with claim 2, wherein:
the control operation unit stops a color calibration operation when the positional misalignment of the color sensor has occurred.
